(19) United States
(12) Patent Application Publication
(10) Pub. No.: US 2023/0156514 A1
(43) Pub. Date: May 18, 2023

(54) USER EQUIPMENT, CORE NETWORK NODE, AND METHODS IN A RADIO COMMUNICATIONS NETWORK

(71) Applicant: Telefonaktiebolaget LM Ericsson (publ), Stockholm (SE)

(72) Inventors: Hans Eriksson, Sollentuna (SE); Tushar Sabharwal, New Delhi (IN); Rohit Shukla, Noida (IN); Rajiv Bhardwaj, Jalandhar (IN); Nipun Sharma, New Delhi (IN)

(21) Appl. No.: 17/916,071

(22) PCT Filed: Mar. 30, 2020
(86) PCT No.: PCT/SE2020/050322

§ 371 Date: Sep. 30, 2022

(51) Int. Cl. H04W 28/02; H04W 24/08

(52) U.S. Cl. CPC H04W 28/0236; H04W 24/08

(57) ABSTRACT

A method performed by first User Equipment (UE) for applying policy enforcement for data traffic in an UL data session is provided. The UL data session is from the first UE to a data network via a Radio Access Network (RAN) a Core Network (CN) and a first Network Slice (NS) in a radio communications network. The UE obtains first information from a CN node in the CN. Upon establishing the UL data session, the UE measures data traffic performance and radio conditions in the RAN. The UE predicts available resources for transmitting data from the first UE towards the data network via the RAN, the CN, and the first NS. The prediction is based on the obtained first information, the measured data traffic performance and radio conditions in the RAN. The UE then applies policy enforcement for the data traffic in the UL data session based on the prediction.

### TECHNICAL FIELD

Embodiments herein relate to network nodes, a User Equipment (UE), a Core Network (CN) node and methods therein. In particular they relate to applying policy enforcement for data traffic in an UL data session in a radio communications network.

### BACKGROUND

In a typical radio communication network, User Equipments (UEs), also known as wireless communication devices, mobile stations, stations (STA) and/or wireless devices, communicate via a Local Area Network such as a Wi-Fi network or a Radio Access Network (RAN) to one or more Core Networks (CN)s. The RAN covers a geographical area which is divided into service areas or cell areas, which may also be referred to as a beam or a beam group, with each service area or cell area being served by a radio access node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR) or new generation, (NG or ng). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In a mobile packet Core Network (CN), there are several flavors of policy control mechanisms. One specific policy relates to fairness policy, i.e. how to do traffic throttling in a fair way between subscribers in the network. For example, when resource congestion is detected in Packet Data Network Gateway (PGW) or User Plane Function (UPF), a traffic throttling rule is enforced on one or several UEs. The wording traffic throttling means reducing the bandwidth and/or QoS for a particular data session. A problem here is how to be fair between the UEs, which UE and how much traffic throttling shall be enforced. The fairness policy rule will try to give fair amount of network resources to all UEs, based on how much of data volume each UE has consumed over a given time period, e.g. during the current month. For example, if one subscribing UE that consumed a lot of capacity, will be throttled down much harder than a subscribing UE that consumed a small amount of data, given that the traffic has the same QoS profiles (e.g. QCI values in 4G). Subscribing UE means a UE having a mobile data subscription at bought from an operator. The traffic throttling in a core network would typically be for down link traffic towards the UE. In addition, traffic throttling in the core network may be made for traffic originating from a specific service network Access Point Name (APN), so that the capacity of PGW/UPF and the resources towards a service network is not overloaded.

This type of rule, i.e. Fairness Policy rules, is based on knowledge about end-user subscription profiles, the amount of data consumed over a given time period, current traffic usage of the UE, and the load in the network.

The problem for the CN fairness policy enforcement is that it needs to know how much capacity can be used, and when, in the UL without trying to send traffic in the UL from the UE. The problem will be more evaluated below.

### SUMMARY

An object of embodiments herein is to improve the performance in how UL fairness is fulfilled in a radio communications network.

According to an aspect of embodiments herein, the object is achieved by a method performed by a first User Equipment, UE, for applying policy enforcement for data traffic in an Uplink, UL, session. The UL data session is from the first UE to a data network via a Radio Access Network, RAN, a Core Network, CN, and a first Network Slice, NS, in a radio communications network.

The UE obtains first information from a CN node in the CN. The first information relates to policy enforcement data for the first NS, and data traffic from second UEs via the RAN, the CN and second NSs. The data traffic information relates to a radio coverage area associated with the location of the first UE. Upon establishing the UL data session, the UE measures data traffic performance and radio conditions in the RAN. The UE predicts available resources for transmitting data from the first UE towards the data network via the RAN, the CN, and the first NS. The prediction is based on the obtained first information, the measured data traffic performance and radio conditions in the RAN. The UE then applies policy enforcement for the data traffic in the UL data session based on the prediction.

According to a further aspect of embodiments herein, the object is achieved by a method performed by a Core Network, CN, node, for assisting a first User Equipment, UE, in applying policy enforcement for data traffic in an Uplink, UL, session. The UL data session is from the first UE to a data network via a Radio Access Network, RAN, a Core Network, CN, and a first Network Slice, NS, in a radio communications network.

The CN node collects policy enforcement data for the first NS. The CN node further collects information relating to data traffic from second UEs via the RAN, the CN and second NSs. The data traffic information relates to a radio coverage area associated with the location of the first UE. The CN node assists the first UE, by sending a first information to the UE. The first information relates to the collected policy enforcement data for the specific NS, and data traffic from the second UEs via the RAN, the CN and second NSs. The sent information assists the first UE to predict available resources for transmitting data traffic in the UL data session based on the sent information, and apply the policy enforcement for the data traffic in the UL data session based on the prediction.

According to a further aspect of embodiments herein, the object is achieved by a first User Equipment, UE, configured to apply policy enforcement for data traffic in an Uplink, UL, session. The UL data session is adapted to be from the first UE to a data network via a Radio Access Network, RAN, a Core Network, CN, and a first Network Slice, NS, in a radio communications network. The UE is configured to:
Obtain first information from a CN node in the CN, which first information is adapted to relate to policy enforcement data for the first NS, and data traffic from second UEs via the RAN, the CN and second NSs. The data traffic information relates to a radio coverage area associated with the location of the first UE.
Upon establishing the UL data session, measure data traffic performance and radio conditions in the RAN.
Predict available resources for transmitting data from the first UE towards the data network via the RAN, the CN, and the first NS, based on the obtained first information, the measured data traffic performance and radio conditions in the RAN.
Apply policy enforcement for the data traffic in the UL data session based on the prediction.

According to a further aspect of embodiments herein, the object is achieved by a Core Network, CN, node, configured to assist a first User Equipment, UE, in applying policy enforcement for data traffic in an Uplink, UL, session. The UL data session is from the first UE to a data network via a Radio Access Network, RAN, a Core Network, CN, and a first Network Slice, NS, in a radio communications network. The CN node is configured to:
Collect policy enforcement data for the first NS.
Collect information relating to data traffic from second UEs via the RAN, the CN and second NSs. The data traffic information is adapted to relate to a radio coverage area associated with the location of the first UE.
Assist the first UE, by sending a first information to the UE. The first information is adapted to relate to the collected policy enforcement data for the specific NS, and data traffic from the second UEs via the RAN, the CN and second NSs. The sent information is adapted to assist the first UE to predict available resources for transmitting data traffic in the UL data session based on the sent information, and apply the policy enforcement for the data traffic in the UL data session based on the prediction.

Thanks to that the first UE predicts available resources for UL data traffic that also considers policy enforcement data for the first NS the performance in how UL fairness is fulfilled in a radio communications network is improved.

Embodiments herein comes with its share of advantages such as e.g.: Improved and efficient, flexible and fair policy enforcement of traffic handling of UEs traffic in network slicing solutions; More optimal use of resources compared to over provisioning in network dimensioning; Reduced risk for wasted resources in up-link, in case of congestion above radio network.

### BRIEF DESCRIPTION OF THE DRAWINGS

FIG. 1 is a schematic sequence diagram illustrating an a method according to prior art.

FIG. 2 is a schematic block diagram illustrating embodiments of a radio communications network.

FIG. 3 is a flowchart depicting a method performed by a UE according to embodiments herein.

FIG. 4 is a flowchart depicting a method performed by a core network node according to embodiments herein.

FIG. 5 is a combined block diagram and sequence diagram depicting embodiments of a method.

FIG. 6 is a combined block diagram and sequence diagram depicting embodiments of a method.

FIGS. 7 a and b are a schematic block diagram illustrating embodiments of a UE.

FIGS. 8 a and b are a schematic block diagram illustrating embodiments of a core network node.

FIG. 9 schematically illustrates a telecommunication network connected via an intermediate network to a host computer.

FIG. 10 is a generalized block diagram of a host computer communicating via a base station with a user equipment over a partially wireless connection.

FIGS. 11-14 are flowcharts illustrating methods implemented in a communication system including a host computer, a base station and a user equipment.

### DETAILED DESCRIPTION

As a part of developing embodiments herein the inventors identified a problem which first will be discussed.

As mentioned above, the problem for the CN fairness policy enforcement is that it needs to know how much capacity that can be used and when, in the UL without trying to send traffic in the UL from the UE.

When congestion happens in RAN, the CN node does not have enough information on affected UEs to make a good decision to make a fair and optimal policy enforcement at the UPF and/or PGW of UEs. Typically a subscriber that consumed its monthly volume is then throttled down or rejected to send more data. A better strategy would be to allow this subscriber to use the network if capacity is available, i.e. gives the possibly to allow the user to consume and pay more, or that the user gets extra data as bonus which also contributes to a good relation with the customers.

In case of congestion in UL traffic from a UE, there is no mechanism in the UE or the RAN that considers the overall subscriber status and traffic statistics and potential risk that UEs may generate high load, when grating traffic from UEs sent in UL direction. In systems today the UL traffic scheduling is based on Quality of Service (QoS) architecture defined in 3GPP, and based on the DL QoS parameters and traffic filtering rules. In the radio domain separated from core network knowledge, the fair usages of radio resources between UEs in the same cell follows a principle of optimal use of the resources, combined with e.g. weighted fair queue scheduling for the local radio resources. No transport or core network considered. In a 5G RAN system, the radio capacity may be much higher than the capacity in the CN node that aggregates several radio nodes. In such case the traffic from a UE carried over the radio interface may be discarded later when it arrives in the CN or in transport network aggregation points, with a higher risk of wasting network resources.

The problem will also be more complex when introducing network slicing. To clarify the problem, a use-case example is given below:

A Communication Service Provider (CSP) is providing network slices as a service with a management interface referred to as NaaS, bundled with several SIM cards and/or identities, possible also UEs, to an enterprise company. The management interface is provided to configure enforcement policies how traffic from enterprise devices such as UEs shall be priorities within a network slice that is dedicated for this enterprise. In this example there are also several other similar enterprise network slices with NaaS that are deployed in the same area with other companies having different requirements of how to prioritize individual UE devices or Internet of Things (IoT) devices. In this example all network slices are using the same network resources, physical and logical Network Function (NF) resources, and in this case the problem will be how to control network resources for individual UE in the same Network Slices (NS), and in between NS.

A current solution is a static over-dimensioning and allocation for sharing of the network resources, this without considering the dynamic traffic behavior between NS and the different requirements defined by the enterprises. It is expected that such over dimensioned system would drive extra cost in transport and CN. Even if CN resources are based on Cloud resources that may scale effective, there is also a cost related to CN functions licensed capacity that requires to be set to a higher capacity to cater for that it is an over dimensioned system. It should also be noted that a fine granular automatics cost scaling of license may be possible for the CN resources, but there is still a cost of scaling transport network that is a more fixed and static resource.

In the example use case above, the QoS architecture would not scale in a good way, as the relation and priority between NS is in control of the operator and/or CSP and how priority rules between UEs in same NS instances is set by the enterprise demands. Given that there may be several hundreds or thousands enterprise customers to one CSP, and there may be hundreds or more of NS instances using same network resources with e.g. hundred or maybe even thousands of IoT devices in one NS instance, the number of QoS classes to separate individual devices, and/or groups of devices, does not scale in a good way. It is also a complicated problem to correlate QoS classes between NS instances and individual UEs in the same NS instance and in different NS instances. The correlation depends on demands from enterprise business agreements with the CSP. In such case an over dimensioned system may be attractive but also costly.

Congestion in addition to radio congestion may be noticed at different nodes and interfaces level as highlighted below
Core Network Function
E.g. UPF, including capacity defined in the license for the product.
Internet Exchange point
   Internet exchange points typically relate to an area where there would be an increased congestion if not the subscriber traffic is throttled down by the gateway in line with the type of subscriptions.
   Is managed outside the mobile operators NOC control.
   Is part of Internet Protocol exchange (IPX) point configurations between Internet Service Providers (ISPs). Here, there is a high probability of application congestion and the application may also give a perception of degraded user experience in a 5G system.
Transport backhaul including transport aggregation points.

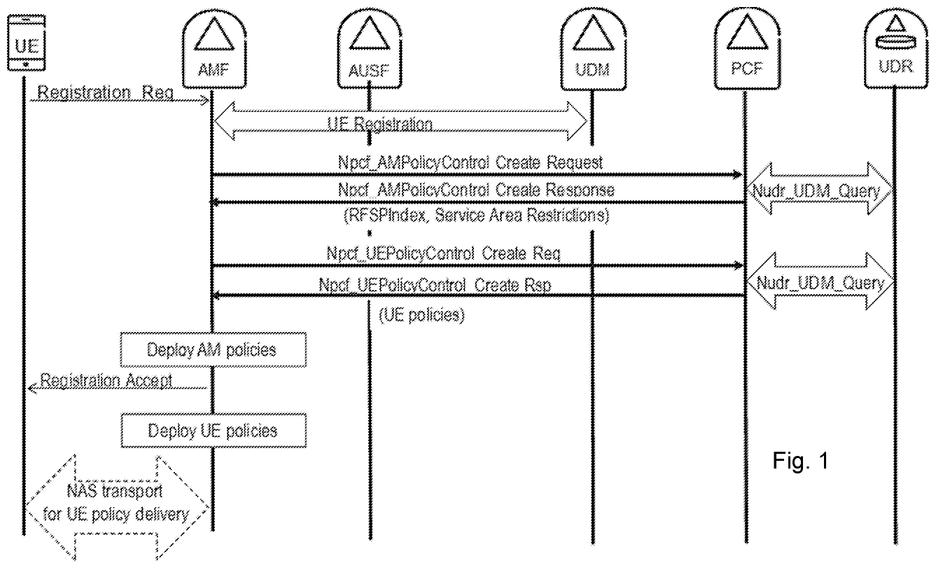

FIG. 1 depicts an example of the process of UE Registration according to prior art. This example will later on in this document be compared with an example of an embodiment herein. In this prior art example, a Policy Charging Function (PCF) provides Access and Mobility management (AM) policies and UE policies. Access and Mobility management Function (AMF) is implicitly subscribed to changes.

The example of FIG. 1 comprises a UE, an AMF node, an Authentication Function (AUSF) node, a User Data Management (UDM) node, a PCF node, and a User Data Repository (UDR) node.

Further in FIG. 1, a Npcf_AMPolicyControl Request (Req) and Response (Rsp) messages are used for requesting and receiving a policy specific to mobility management and UE specific policy.

Npcf_UEPolicyControl Create Request (Req) and Response (Rsp) messages are used for requesting and delivering of UE policies.

Nudr_UDM_Query messages are used for requesting and delivering policy control related subscription information and application specific information stored in the UDR.

NAS means Non-Access-Stratum.

Some additional information to clarify the problem may comprise as follows:

A packet core network does not have any information on which UE's is camping in same radio coverage area, cell and/or sector, and this may result in:

1) That the CN would enforce throttling on UEs traffic even if the UE is alone in the specific radio coverage area;

2) That UE then will send UL traffic even if the backhaul would be congested, which results in unnecessary traffic load in the UL direction in the radio network, increasing the risk of radio resource congestion in that area;

3) That the UE will send UL traffic and the CN would discard or apply bandwidth limiting for this UE to avoid resource congestion in the CN or higher up as in peering points, due to that aggregation of traffic is done of other UE's in other radio network connected to same CN node.

For the first case 1), a better strategy would be that the UE continues to consume network resources as long as there is no impact on other users, and as long as subscription/business agreement is not violated, which is provided by some embodiments herein. Users of UEs that experience throttling of traffic will get a negative user experience and it should be avoided if not needed. Throttling of traffic also reduce the likelihood that end-user UEs need to buy more data volume, which has a negative impact on operator's business opportunity.

For the case 2) it would be better to apply policy enforcement in the UE for UL avoiding sending unnecessary, or too much, data to a congested backhaul which is provided by some embodiments herein.

For the case 3) it would be better to apply policy enforcement in the UE for UL avoiding sending unnecessary, or too much, data to a congested core network, which is provided by some embodiments herein.

An object of embodiments herein is to improve the performance in how UL fairness is fulfilled in a radio communications network.

Embodiments herein provide to distribute part of the core network's policy enforcement mechanism of subscription related fairness rules down to the UE.

Example embodiments herein relate to a Method and a System for CN policy enforced up-link control in a UE.

In 5G it is likely that congestion and throttling of traffic happens higher up in the network and not only in the RAN. In addition, the business related SLA parameters and subscription data are used to set priority data for policy enforcements on how traffic shall be scheduled. For this reason embodiments herein provide a prediction of available resources for transmitting data that is based on data compiled higher up in the network and then downloaded in the UE. The traffic policy enforcements in the UE covers throttling of traffic to fit radio resources and predicted available resources higher up in the network. Traffic may also be delayed for transmission from the UE. The UE method according to some embodiments herein will have a monitoring function, checking how well performance is met, and new data will be updated from the network to the UE to improve the performance in how UL fairness is fulfilled.

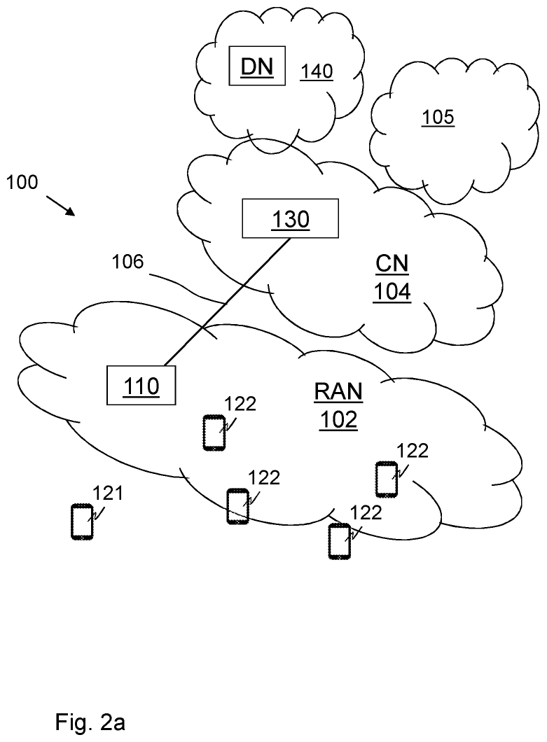

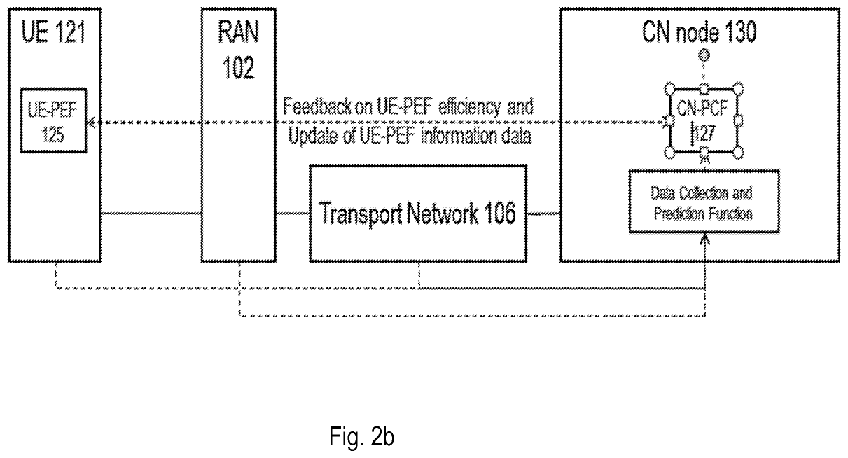

FIG. 2a and FIG. 2b show a schematic overview depicting a radio communications network 100 wherein embodiments herein may be implemented. The radio communications network 100 comprises one or more RANs such as the RAN 102, and one or more CNs such as the CN 104 with transport networks such as the transport network 106 in between. The radio communications network 100 may use a number of different technologies, such as W-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

Network nodes operate in the radio communications network 100 such as a network node 110. The network node 110 is comprised in the RAN 102 and provides radio coverage over a geographical area, a service area referred to as a cell, which may also be referred to as a beam or a beam group of a first radio access technology (RAT), such as 5G, LTE, W-Fi or similar. The network node 110 also provides radio coverage over a geographical area, a service area referred to as a cell, which may also be referred to as a beam or a beam group of a first radio access technology (RAT), such as 5G, LTE, Wi-Fi or similar. The network node 110 may each be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area served by the network node 110 depending e.g. on the first radio access technology and terminology used. The network node 110 may be referred to as radio nodes and may communicate with a UE 120 with Downlink (DL) transmissions to the UE 120 and Uplink (UL) transmissions from the UE 120.

A number of UEs operate in the wireless communication network 100, such as the first UE 120 and second UEs 122. The second UEs 122 may be other UEs than the first UE 121, or the first UE 121 may be one of the second UEs.

Each of first UE 120 and second UEs 122 may be a mobile station, a non-access point (non-AP) STA, a STA, a user equipment and/or a wireless terminals, that communicate via the RAN 102, e.g. via the network node 110, the transport network 106, the CN e.g. comprising a CN node 130 to a data network 105, e.g. the Internet. It should be understood by the skilled in the art that “UE” is a non-limiting term which means any terminal, wireless communication terminal, user equipment, Machine Type Communication (MTC) device, IoT device, Device to Device (D2D) terminal, or node e.g. smart phone, laptop, mobile phone, sensor, relay, mobile tablets or even a small base station communicating within a cell.

The first UE 120 may comprise a UE-Policy Enforcement Function (PEF) module 125 and the CN node 130 may comprise a CN-PCF module 127. See FIG. 2b. The first UE 120 may or may not be one of the second UEs 122.

Methods herein may in a first aspect be performed by the UE 120, and in a second aspect by the CN nodes 130. As an alternative, a Distributed Node (DN) and functionality, e.g. comprised in a cloud 140 as shown in FIG. 2a, may be used for performing or partly performing the methods.

Network slice services are provided in the radio communications network 100.

FIG. 2b will be further described below.

Embodiments herein provide a method to execute part of CN policy enforcement in the UE 120 for UL traffic. The method build on a proactively prediction on how to do UL traffic enforcements in such a way that fairness between UEs such as the UE 120, network slices, and in relations to business agreements are met.

Embodiments herein provide to deploy to the UE 120, e.g. to a deploy to the UE-PEF module 125 in the UE 120, for traffic management enforcing CN policy rules in the UE 120, where the required policy input data is received from the CN node 130. Some embodiments also allows continues adaptations to tune the UE 120 data such as UE-PEF data to allow for optimal and fair traffic scheduling depending on location and time of day variations.

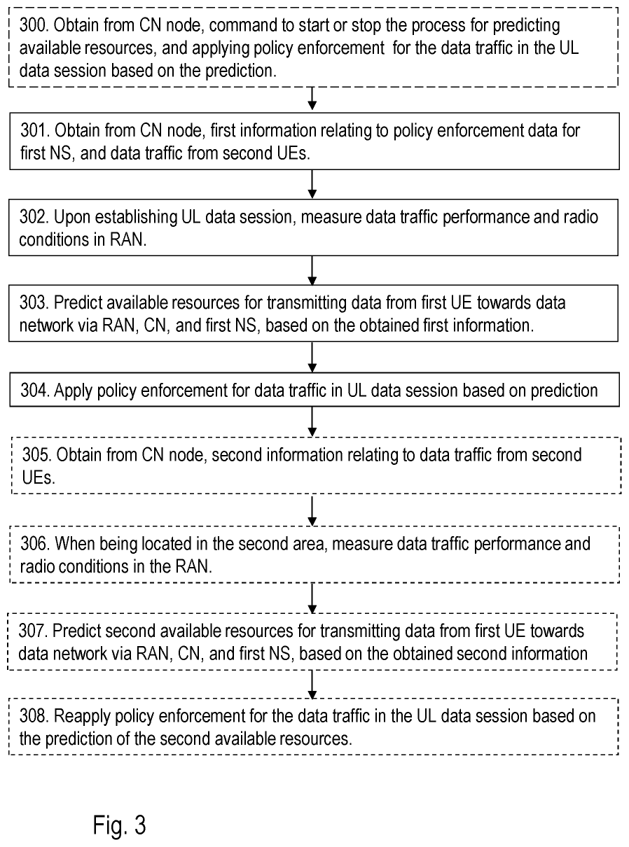

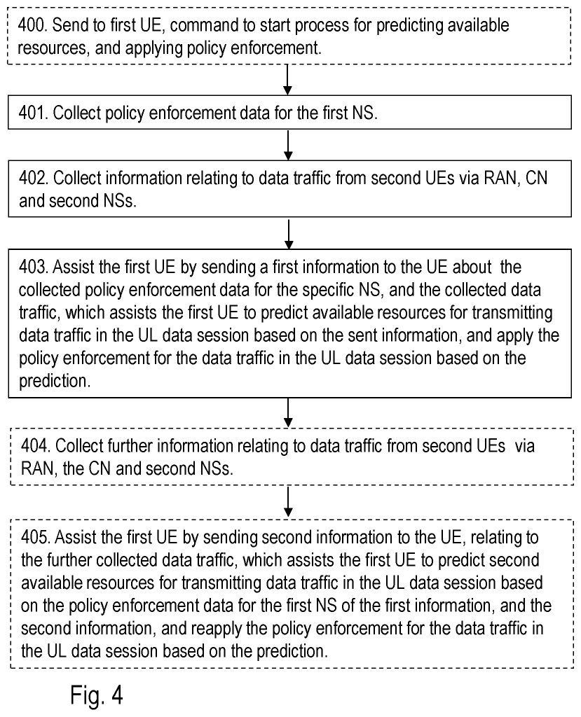

Embodiments herein will first be described in a more general way together with FIGS. 3 and 4. This will be followed by a more detailed description of the embodiments.

FIG. 3 shows an example method performed by the first UE 121 for applying policy enforcement for data traffic in an UL data session. Policy enforcement when used herein e.g. means policy defining capacity over time in UL that a UE such as the first UE 121, may use, and to be implemented in UE, such as the first UE 121, which may be viewed as recommendation and/or prediction from the CN 104. The policy enforcement may e.g. be fairness policy enforcement. The UL data session is from the first UE 121 to the data network 105 via the RAN 102, the CN 102, and a first Network Slice (NS) in the radio communications network 100. It should be noted that the wording via the RAN 102 and the CN 102 when used herein, also comprises the transport network 106 between the RAN 102 and the CN 102, and further possibly also transport to other packet data networks.

The method comprises one or more of the following actions, which actions may be taken in any suitable order. Actions that are optional are marked with dashed boxes in the figure.

According to an example scenario, the first UE 121 wishes to set up an UL data session from the first UE 121 to the data network 105 via the RAN 102, the transport network 106, the CN 102, and a first Network Slice (NS) in the radio communications network 100.

Action 300. The CN node 130 may switch on and off the process for predicting available resources. This may e.g. be performed by switch on and off the state of the UE-PEF module 125 in the UE 121. This may be performed depending on e.g. there is a need to make traffic enforcements in the UL to differentiate between NSs e.g. based on SLA data for the NS, there is enough data to do predictions, or if there is no risk for high traffic situations in the area or by operator preferences. Thus, in some embodiments, the first UE 121 obtains a command from the CN node 130, e.g. comprised in in a message received from the CN node 130. The command is to start or stop the process for predicting available resources in Action 303 below, and applying policy enforcement in Action 304 below, for the data traffic in the UL data session based on the prediction.

Action 301. In order to be able to predict available resources for performing the transmitting of the data from the first UE 121 towards the data network 105 via the RAN 102, the CN 102, and the first NS, and apply policy enforcement for the data traffic in the UL data session based on the prediction, the first UE 121 needs to know policy enforcement data for the first NS and the current data traffic performance and radio conditions in the RAN 102. The policy enforcement data may include policy enforcement information over time, e.g. daily profiles of the predicted capacity that is available for the first UE 121 in this specific NS, in this location. Thus, the first UE 121 obtains first information from the CN 102 node 130 in the CN 102. The first information relates to policy enforcement data for the first NS. The first information further relates to data traffic from second UEs 122 via the RAN 102, the CN 102 and second NSs. The second UEs 122 may mean other UEs than the first UE 121 or the first UE 121 may be one of the second UEs. The data traffic information relates to a radio coverage area associated with the location of the first UE 121. The policy enforcement data for the first NS may comprise any one or more out of: Location information of the first UE 121, a QoS priority level to use, maximum throughput to use in the first and/or second area, and a time of day, what policy enforcement to use, and if activated or not. The policy enforcement data may have a time of day profile with different enforcement information's depending on time of day.

Action 302. Upon establishing the UL data session, the first UE 121 measures data traffic performance and radio conditions in the RAN 102.

Action 303. Now, the first UE 121 knows the policy enforcement data for the first NS, and the current data traffic performance and radio conditions in the RAN 102. The first UE 121 is therefore capable of predicting the available resources for performing the transmitting of the data from the first UE 121 towards the data network 105 via the RAN 102, the CN 102, and the first NS. Thus, the first UE 121 predicts available resources for transmitting data from the first UE 121 towards the data network 105 via the RAN 102, the CN 102, and the first NS, based on the obtained first information, and the measured data traffic performance and radio conditions in the RAN 102.

Action 304. The first UE 121 applies policy enforcement for the data traffic in the UL data session based on the prediction.

In some embodiments, wherein the first UE 121 is moving into a second location, the Actions 305, 306, 307 and 308 below may be performed. Different areas will have quite different type of data traffic during the day. When the UE 121 is moving into a second location in a new area, the traffic data for the area is downloaded to the UE 121 if needed, e.g. new area for the UE 121, referred to as the second area. This allows the traffic policy method in the UE 121 to predict and schedule the traffic according to the new data parameters.

Action 305. The first UE 121 may obtain second information from the CN node 130 in the CN 102. The second information relates to data traffic from second UEs 122 via the RAN 102, the CN 102 and second NSs. The data traffic information relates to a radio coverage area associated with the second location of the first UE 121.

Action 306. When being located in the second area, the first UE 121 may measure data traffic performance and radio conditions in the RAN 102.

Action 307. The first UE 121 then predicts second available resources for transmitting data from the first UE 121 towards the data network 105 via the RAN 102, the CN 102, and the first NS. The second prediction is based on the policy enforcement data for the first NS obtained in the first information, the obtained second information, and the data traffic performance and radio conditions in the RAN 102 measured when being located in the second area.

Action 308. The first UE 121 reapplies policy enforcement for the data traffic in the UL data session based on the prediction of the second available resources.

FIG. 4 shows an example method performed by the CN node 130 for assisting the first UE 121 in applying policy enforcement for data traffic in an UL data session. The UL data session is from the first UE 121 to the data network 105 via the RAN 102, the CN 102, and the first NS in the radio communications network 100. As mentioned above, the wording “via the RAN 102 and the CN 102”, may also comprise the transport network 106 between the RAN 102 and the CN 102.

The method comprises one or more of the following actions, which actions may be taken in any suitable order. Actions that are optional are marked with dashed boxes in the figure.

Action 400. In some embodiments, the CN node 130 sends to the first UE 121, a command to start the process for predicting available resources, and applying policy enforcement for the data traffic in the UL data session based on the prediction.

Action 401

The CN node 130 collects policy enforcement data for the first NS.

Action 402. The CN node 130 further collects information relating to data traffic from second UEs 122 via the RAN 102, the CN 102 and second NSs. The data traffic information relates to a radio coverage area associated with the location of the first UE 121.

Action 403. The CN node 130 then assists the first UE, 121 by sending a first information to the first UE 121. The first information relates to the collected policy enforcement data for the specific NS, and the collected data traffic from the second UEs 122 via the RAN 102, the CN 102 and second NSs.

The sent information assists the first UE 121 to predict available resources for transmitting data traffic in the UL data session based on the sent information, and apply the policy enforcement for the data traffic in the UL data session based on the prediction.

In some embodiments, wherein the first UE 121 is moving into a second location, the Actions 404, 405 and 406 below may be performed.

Action 404. In these embodiments, the CN node 130 collects further information relating to data traffic from second UEs 122 via the RAN 102, the CN 102 and second NSs. The data traffic information relates to a radio coverage area associated with the second location of the first UE 121.

Action 405. The CN node 130 may then assist the first UE 121 by sending a second information to the UE 121. The second information relates to the further collected data traffic from the second UEs 122 via the RAN 102, the CN 102 and second NSs.

The sent second information assists the first UE 121 to predict second available resources for transmitting data traffic in the UL data session based on the policy enforcement data for the first NS obtained in the first information, and the sent second information, and reapply the policy enforcement for the data traffic in the UL data session based on the prediction.

The embodiments above will now be further explained and exemplified. The examples and embodiments below may be combined with any suitable embodiment as described above.

Example embodiments herein build on a prediction method in the first UE 121 for UL traffic that also considers CN traffic fairness usage rules for policy enforcement. The example method estimates available capacity, e.g. for a time period in question. Estimation based on earlier historical data traces for the specific area related to the location of the first UE 121, and for the capacity consumed by first UE 121 in the area, and NS data such as the policy enforcement data for the first NS, defined by e.g. Enterprise demands on how to prioritize between UEs in the NS.

This method may be downloaded in the first UE 121, and populated with relevant information for the given area, e.g. a Tracking Area (TA). As mentioned above, different areas will have quite different type of traffic during the day, and when the first UE 121 is moving into a new area the traffic data for the area may be downloaded to the first UE 121 if needed, e.g. new area for the first UE 121, allowing the traffic policy method in the first UE 121 to predict and apply policy enforcement for the data traffic in the UL data session such as e.g. schedule the data traffic according to the new data parameters.

To apply policy enforcement, e.g. implement UL traffic fairness policy enforcement in the first UE 121, additional knowledge is required on resource consumption of the first NS. The policy how to prioritize in between the UE's in the same network slice e.g. comprising the first UE 121, in the same radio coverage area and/or cell. In addition also the relation between the first UE 121 and other UE's, e.g. second UEs 122 in other network slices in same coverage area may preferably be considered when setting the priority order and when predicting, e.g. estimating, available resources, this to avoid any violations of Service level agreement (SLA) for business agreements.

The policy enforcement method according to some embodiments herein covers bandwidth limiting and/or throttling of UE UL-traffic in relation to other UEs in the same area. The method may also take subscription agreements into account as part of the policy enforcement strategy for those UEs.

Referring again to FIG. 2b, showing some blocks of the radio communications network 100 such as a telecommunication 3GPP system, related to an example embodiment herein.

In below examples the wordings first UE 121, UE-PEF and UE-PEF module 125 may be used interchangeable In the below examples the first UE 121 is represented by the UE-PEF 125. Further, the CN node 130, CN-PCF and CN-PCF module 127 may be used interchangeable in this example the CN node 130 is represented by the UE-PEF 125.

A group of UEs operate in the radio communications network 100 that belongs to the same or to different network slices within the same radio communications network 100 e.g. comprising the first UE 121 belonging to the first NS. Network slicing is defined in 3GPP and is not shown, but it is well understood by person skilled in art. The node and names shown is defined in 3GPP specification TS 23.501. In embodiments herein, a PEF is introduced in the first UE 121 for UL traffic. The UE-PEF communicates with the core network policy function, referred to as CN-PCF comprised in the CN node 130, for the purpose of policy enforcement such as adjusting traffic scheduling, based on received data information and/or policy from the Core Network. The policy enforcement data e.g. of the first NS, covers, but not limited to, location information, e.g. cell or group of cells, Global Positioning System (GPS) positions, the QoS priority level to use, max throughput to use in that area and the time of day the policy is valid. The policy information may be a list of location data covering a larger area. Based on the data from CN node 130 and local available measurements performed by the first UE 121 on data traffic performance and radio conditions, the UE-PEF makes a prediction on how much data that can be sent for the current location. The method builds on a prediction and to tune the performance to utilize as much as possible in the CN 104 and transport network 106 capacity, also considering long term traffic variations, e.g. a daily profile. The CN node 130 may update the first UE 121 such as its UE-PEF with new data to tune the prediction to get a better total network performance and utilization.

The first UE 121 such as its UE-PEF may also send Key Performance Indicators (KPI) data feedback to the CN 102 such as the CN node 130, about throughput, radio congestion for the area and when in time. Based on received feedbacks from a several UEs and the utilization of infrastructure resources the CN 102 such as the CN node 130 may re-calculate the UE-PEF data to meet the expected service level agreements for the different network slices.

The UE-PEF data may be based on statistical measures and tuned to fit the algorithms implemented in the UE-PEF. The UE-PEF 125 may be a downloadable Software (SW) module. The way to download that SW may be done in several different ways using similar mechanisms as when downloading applications (APPs) from an app store, e.g. by manual user request, or as an automatic request initiated by the first UE 121 or Network functions, or by downloading and install during production or post-production phase and may also be pre-installed hardware (HW) and SW of the first UE 121. How to download the UE-PEF is not described further as SW/APP installation of the first UE 121 is considered to be prior art and well known.

There may be phases of embodiments herein, pre-enforcement and post enforcement phases. The pre-enforcement phase is when “normal” operation before switching on the UE-PEF. The post-collection phase is when the UE-PEF is active. The CN 102 such as the CN node 130 may switch on and off the state of the UE-PEF depending on e.g. there is a need make traffic enforcements in the UE UL to differentiate between NSs based on SLA data for the NS such as the first NS, enough data to do predictions, or if there is no risk for high traffic situations in the area or by operator preferences.

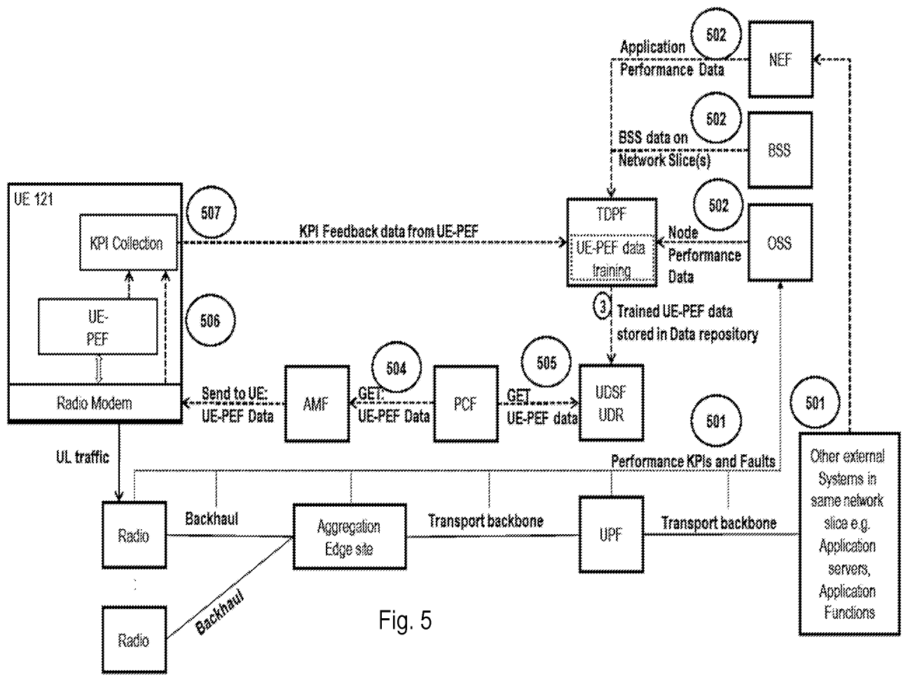

FIG. 5, depicts a more detailed block diagram of an example embodiment, including an overview of a sequence diagram.

The below actions refer to FIG. 5 and describes the additional new functions according to embodiments herein.

Pre-Enforcement Phase:

Action 501: Performance metrics, counters, etc, is collected by an Operations support system (OSS) from nodes, network transport systems and collected by Network Exposure Function (NEF) from external systems such as application functions and servers. The external system may also be part of the NS, such as the first NS, e.g. belonging to the same network slice e.g. for an enterprise deployment.

Action 502: the OSS and the NEF send collected performance data to the Traffic Data and Prediction Function (TDPF). The OSS data is e.g. counter values collected from the radio communication network 100 and nodes, and the NEF data may be feedback data from application functions on how the performance is perceived by the application, e.g. KPI values on throughput in relation to SLA definition, latency responses for a given time and area. Note that the NEF received data is optional and expected to only be available for e.g. critical applications with stricter requirements, but does not need to be limited to that.

A Business Support System BSS sends for each new, or for each changed business agreement, NaaS data including e.g. Subscriber Identity Module (SIM) Identity (ID)s, Network Slice ID, and network slice SLA data that corresponds to the business agreements with the customers, e.g. Enterprises and/or Industries.

Action 503: The UE-PEF data for the NS, the areas where the UE-PEF shall be used, time of day data, and for witch UE it is valid, is stored in an Unstructured Data Storage Function (UDSF), unstructured data, i.e. non-standardized data structure, or as structured data in User Data Repository (UDR) (standardized structure), or possible in both with some differences that vendor specific addition is stored in UDSF.

Action 504: During UE registration, also referred to as Attach, procedure or during radio bearer and Packet Data Network (PDN) connection establishment, the AMF requests AM and UE policy data from PCF.

Action 505: The PCF compiles the UE policy enforcement data from the UDR and/or UDSF, that may also be configured with other subscription data and business data. The configured UE-PEF data is returned to the AMF, e.g. as part of other UE policies or in a separate message.

Action 506: The AMF may send this new UE-PEF data such as the policy enforcement rule such as the policy enforcement data for the first NS, as part of Registration procedure, PDN connection establishment, or as a separate message using NAS protocol, Data over NAS.

The new UE-PEF data is installed and activated.

Action 507: The UE-PEF monitors the traffic performance and compares this new data with the UE-PEF data received from the CN 102 such as the CN node 130. The statistic is analyzed, and KPI performance feedback is sent, in case lager deviations is found, over NAS protocol, e.g. via the AMF, to the TDPF as input for further refinements of the UE ML model for UL traffic. In this example, the TDPF subscribes to those data over NAS messages from the AMF. Subscription of NAS messages is part of 3GPP 5G Service Based Architecture (SBA) mechanism and is not further described here.

UE-PEF data description of the data such as policy enforcement data for the first NS received from CN node 130 may comprise:
E.g. the radio coverage area comprising Geographic area description defined by e.g. Tracking area(s), cell(s), RBS identifier(s), GPS coordinates. The size of the area may be defined on that similar traffic statistical properties is identified. The definition of an area may be done by manual configuration or by automated function in classifying the areas.
For each area, such as the radio coverage area, a description of:
   Statistical properties that describes the characteristics of an area would be, but not limited to, for a Time of day profile(s) that comprises a number of UEs in the area, average traffic demands with a variation margin of used capacity, probability of congestions over the radio, i.e. buffer level in the first UE 121 due to congestion, and probability of congestions above the network node 110 comprised in the RAN 102, i.e. the transport network 106 and the CN 104, and the probability of how frequent it may happen. In addition, the first UE 121 reported neighboring cell list may be given, may also include received signal strength, to make a finer granular view of the area the first UE 121 is located in. The historical values of neighboring cell list reported from the first UE 121, may be compared with the by the first UE 121 current measured neighboring cell list. This is to determine the first UE's 121 relation to an actual location in relation to historical measures and statistical predicted conditions would be close to similar situations. This to determine the best strategy for how to enforce traffic regulations in the first UE 121 such as its UE-PEF.
   Network slice identifier.
   Priority of the UE traffic and the allowed priority level tuning that the first UE 121 such as its UE-PEF may use if allowed to be used, defined by the CSP requirements, and data derived from BSS.
   Bearer traffic parameters, e.g. in case different bearer capabilities could be requested from the first UE 121, and Target value on allowed average UL traffic, and max allowed UL throughput.
   For above parameters a weighted priority for each parameter may be given (optional) to tune the UE-PEF prediction on traffic policy enforcement levels to use.

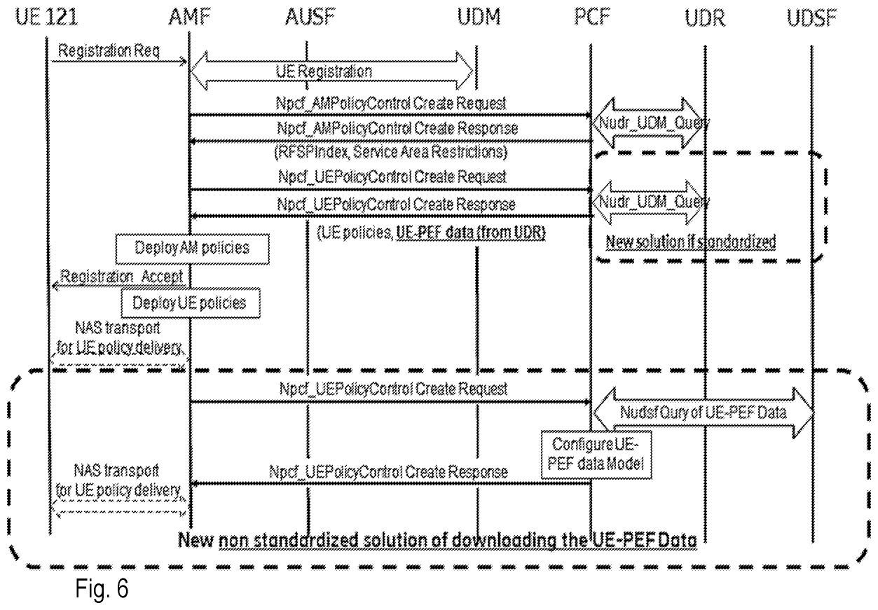

FIG. 6 depicts downloading of UE-PEF Data at Registration of UE according to embodiments herein. Please see FIG. 1 for comparison with prior art.

FIG. 1 (prior art) and FIG. 6 describes a UE registration procedure, also referred to as Attach procedure. Similar sequence, but not shown here, would also be consider for a PDN connection establishment to update the policy enforcement data for the first NS such as the UE-PEF data, if required.

There may be at least two alternative embodiments of downloading UE-PEF data, standardized or non-standardized, shown it the above figure.

In the first alternative embodiment, the policy enforcement data for the first NS such as the UE-PEF data is part of a standardized solution, it may be stored in the UDR for structured data, and a Machine Learning (ML) model is included in a “normal” UE policies container in a message as shown in the upper part of FIG. 6, underlined and encircled by a striped line.

In the second alternative embodiment, the lower part of FIG. 6 indicted as underlined and encircled by a striped line, executes after the registration procedure is completed. In this embodiment the AMF requests additional UE-PEF data policies for policy enforcement in the first UE 121, from the PCF. In this case the PCF requests the policy enforcement data for the first NS such as the UE-PEF data from the unstructured data storage UDSF. UDSF and UDR are defined in 3GPP and is not further described here.

This second alternative embodiment may also be added after that a new PDU Session Establishment has been made. As PDN connection may have different policy enforcement strategies and different throttling levels, and that it may have changed since first Registration was made, an update of UE-PEF data may be required.

The AMF, AUSF, UDM, PCF, UDR, and/or UDSF may be comprised in the CN 102, e.g. in the CN node 130.

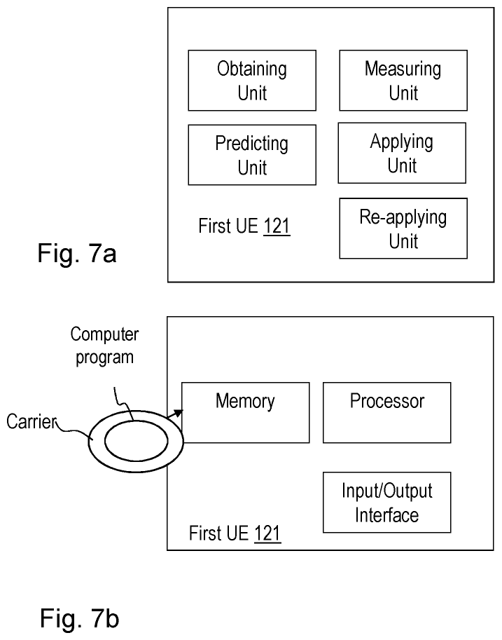

To perform the method actions described above, the UE 120 may comprise an arrangement as shown in FIGS. 7a and 7b.

The UE 120 may comprise an input and output interface configured to communicate with each other, see FIG. 7b. The input and output interface may comprise a wireless receiver (not shown) and a wireless transmitter (not shown).

As seen in FIG. 7a, the UE 120 may comprise an obtaining unit, a measuring unit, a predicting unit, an applying unit and a re-applying unit.

The first UE 121 is configured to apply policy enforcement for data traffic in an UL data session. The UL data session is adapted to be from the first UE 121 to a data network 105 via the RAN 102, the CN, and the first NS in the radio communications network 100.

The first UE 121 is configured to, e.g. by means of the obtaining unit in the first UE 121, obtain first information from a CN node 130 in the CN, which first information is adapted to relate to policy enforcement data for the first NS, and data traffic from second UEs 122 via the RAN 102, the CN and second NSs. The data traffic information relates to a radio coverage area associated with the location of the first UE 121.

The first UE 121 is further configured to, e.g. by means of the measuring unit in the first UE 121, upon establishing the UL data session, measure data traffic performance and radio conditions in the RAN 102.

The first UE 121 is further configured to, e.g. by means of the predicting unit in the first UE 121, predict available resources for transmitting data from the first UE 121 towards the data network 105 via the RAN 102, the CN, and the first NS. The predicting is to be based on the obtained first information, the measured data traffic performance and radio conditions in the RAN 102.

The first UE 121 is further configured to, e.g. by means of the applying unit in the first UE 121, apply policy enforcement for the data traffic in the UL data session based on the prediction.

Some embodiments relate to an example wherein the first UE 121 is movable into a second location.

In these embodiments, the first UE 121 may further be configured to, e.g. by means of the obtaining unit in the first UE 121, obtain second information from a CN node 130 in the CN. The second information is adapted to relate to data traffic from second UEs 122 via the RAN 102, the CN and second NSs. The data traffic information relates to a radio coverage area associated with the second location of the first UE 121.

In these embodiments, the first UE 121 may further be configured to, e.g. by means of the measuring unit in the first UE 121, when being located in the second area, measure data traffic performance and radio conditions in the RAN 102.

In these embodiments, the first UE 121 may further be configured to, e.g. by means of the predicting unit in the first UE 121, predict second available resources for transmitting data from the first UE 121 towards the data network 105 via the RAN 102, the CN, and the first NS. The prediction is based on the policy enforcement data for the first NS obtained in the first information, the obtained second information, the data traffic performance and radio conditions in the RAN 102 measured when being located in the second area.

In these embodiments, the first UE 121 may yet further be configured to, e.g. by means of the re-applying unit in the first UE 121, reapply policy enforcement for the data traffic in the UL data session based on the prediction of the second available resources.

The first UE 121 may further be configured to, e.g. by means of the obtaining unit in the first UE 121, obtain from the CN node 130, a command to start or stop the process for predicting available resources, and applying policy enforcement for the data traffic in the UL data session based on the prediction.

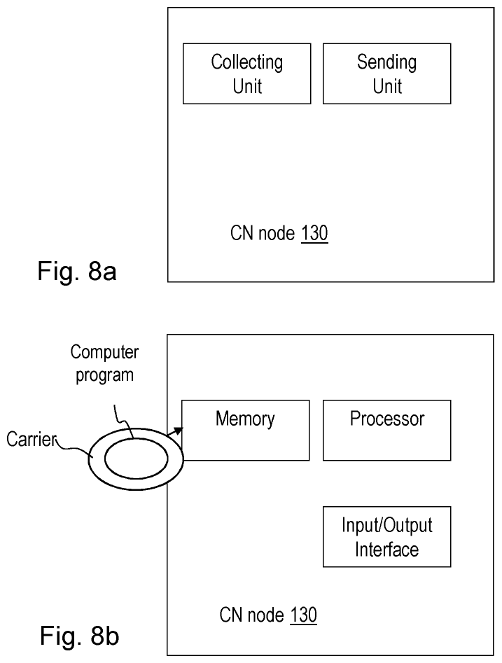

To perform the method actions described above, the CN node 130 may comprise an arrangement as shown in FIGS. 8a and 8b.

The CN node 130 may comprise an input and output interface configured to communicate with each other, see FIG. 8b. The input and output interface may comprise a wireless receiver (not shown) and a wireless transmitter (not shown).

As seen in FIG. 8a, the CN node 130 may comprise a collecting unit, and a sending unit.

The CN node 130 is configured to assist the first UE 121 in applying policy enforcement for data traffic in an UL data session. The UL data session is from the first UE 121 to a data network 105 via the RAN 102, the CN and the first NS in the radio communications network 100.

The CN node 130 is further configured to, e.g. by means of the collecting unit in the CN node 130, collect policy enforcement data for the first NS.

The CN node 130 is further configured to, e.g. by means of the collecting unit in the CN node 130, collect information relating to data traffic from second UEs 122 via the RAN 102, the CN and second NSs. The data traffic information is adapted to relate to a radio coverage area associated with the location of the first UE 121.

The CN node 130 is further configured to, e.g. by means of the sending unit in the CN node 130, assist the first UE, 121 by sending a first information to the UE 121. The first information is adapted to relate to the collected policy enforcement data for the specific NS, and the data traffic from the second UEs 122 via the RAN 102, the CN and second NSs. The sent information is adapted to assist the first UE 121 to predict available resources for transmitting data traffic in the UL data session based on the sent information, and apply the policy enforcement for the data traffic in the UL data session based on the prediction.

Some embodiments relate to an example wherein the first UE 121 is movable into a second location.

In these embodiments, the CN node 130 may further be configured to, e.g. by means of the collecting unit in the CN node 130, collect further information relating to data traffic from second UEs 122 via the RAN 102, the CN and second NSs. The data traffic information is adapted to relates to a radio coverage area associated with the second location of the first UE 121.

In these embodiments, the CN node 130 may further be configured to, e.g. by means of the sending unit in the CN node 130, assist the first UE, 121 by sending a second information to the UE 121. The second information is adapted to relate to the further collected data traffic from the second UEs 122 via the RAN 102, the CN and second NSs. The sent second information is adapted to assist the first UE 121 to predict second available resources for transmitting data traffic in the UL data session based on the policy enforcement data for the first NS obtained in the first information, and the sent second information, and re-apply the policy enforcement for the data traffic in the UL data session based on the prediction.

In some embodiments, the CN node 130 may further be configured to, e.g. by means of the sending unit in the CN node 130, send to the first UE 121, a command to start the process for predicting available resources, and applying policy enforcement for the data traffic in the UL data session based on the prediction.

The embodiments herein may be implemented through a respective processor or one or more processors, such as the processor of a processing circuitry in the respective first UE 121 and the CN node 130 depicted in respective FIG. 7b and FIG. 8b, together with computer program code for performing the functions and actions of the embodiments herein. The program code mentioned above may also be provided as a computer program product, for instance in the form of a data carrier carrying computer program code for performing the embodiments herein when being loaded into the respective first UE 121 and the CN node 130. One such carrier may be in the form of a CD ROM disc. It is however feasible with other data carriers such as a memory stick. The computer program code may furthermore be provided as pure program code on a server and downloaded to the respective first UE 121 and the CN node 130.

The first UE 121 and the CN node 130 may further comprise a respective memory comprising one or more memory units. The memory comprises instructions executable by the processor in the first UE 121 and the CN node 130. The memory is depicted in respective FIG. 7b and FIG. 8b.

The respective memory is arranged to be used to store e.g. policy enforcement data for the first NS, data traffic from second UEs 122 via the RAN, the CN and second NSs, information, data, configurations, and applications to perform the methods herein when being executed in the first UE 121 and the CN node 130.

In some embodiments, a respective computer program comprises instructions, which when executed by the at least one processor, cause the at least one processor of the first UE 121 and the CN node 130 to perform the actions above. The computer program is depicted in respective FIG. 7b and FIG. 8b.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium. The carrier is depicted in respective FIG. 7b and FIG. 8b.

Those skilled in the art will also appreciate that the units in the respective first UE 121 and CN node 130, described above may refer to a combination of analog and digital circuits, and/or one or more processors configured with software and/or firmware, e.g. stored in the first UE 121 and the CN node 130, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

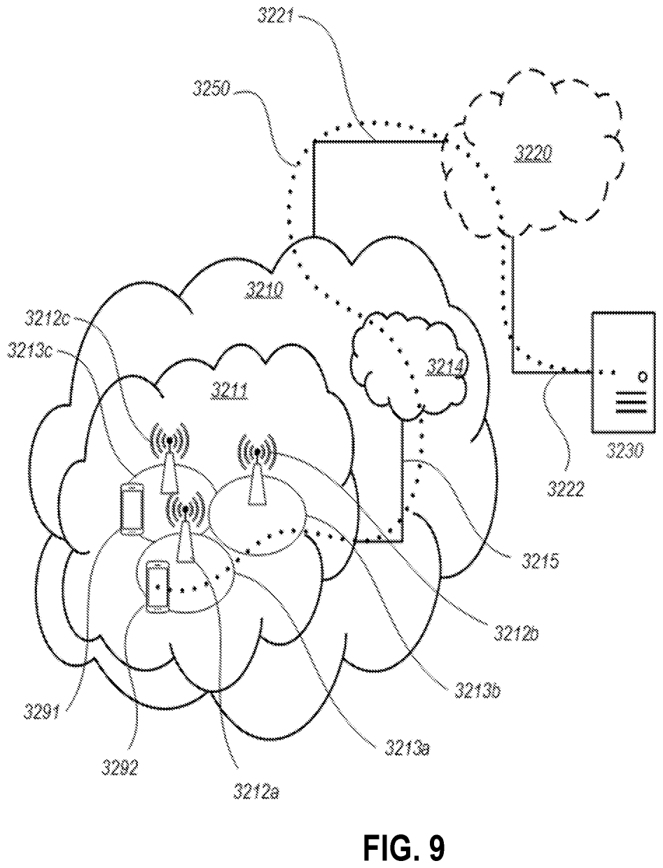

With reference to FIG. 9, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the source and target access node 111, 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 such as e.g. the UE 120, and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

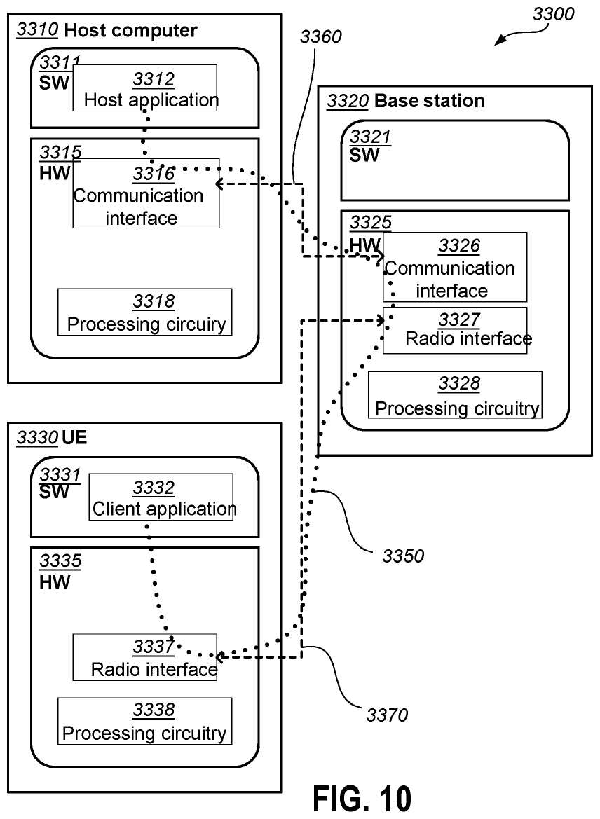

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. The expression “embodiments described throughout this disclosure” is meant to refer to the radio-related embodiments disclosed elsewhere in the application. One or more of the various embodiments improve the performance of OTT services provided to the UE 3330 using the OTT connection 3350, in which the wireless connection 3370 forms the last segment. More precisely, the teachings of these embodiments may e.g. improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

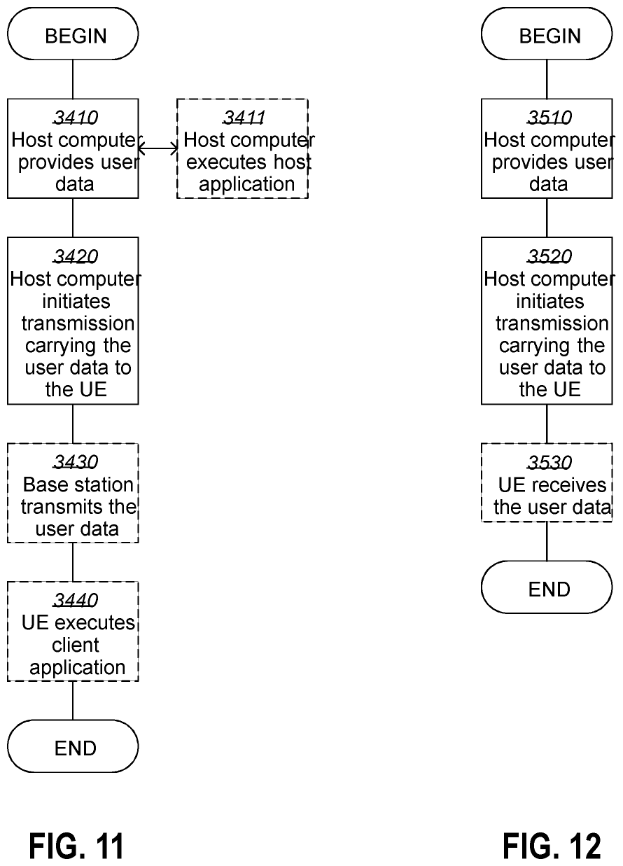

FIG. 11 is a flowchart illustrating a method implemented in a communication system, in accordance with one embodiment. The communication system includes a host computer, a base station such as a AP STA, and a UE such as a Non-AP STA which may be those described with reference to FIG. 9 and FIG. 10. For simplicity of the present disclosure, only drawing references to FIG. 11 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 9 and FIG. 10. For simplicity of the present disclosure, only drawing references to FIG. 12 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

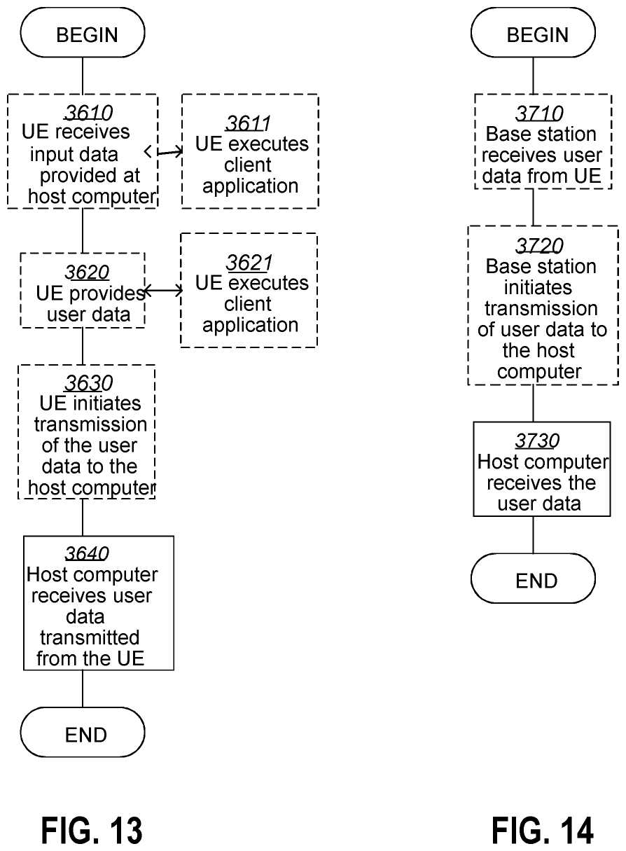

FIG. 13 is a flowchart illustrating a method implemented in a communication system, in accordance with one embodiment. The communication system includes a host computer, a base station such as a AP STA, and a UE such as a Non-AP STA which may be those described with reference to FIG. 9 and FIG. 10. For simplicity of the present disclosure, only drawing references to FIG. 13 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 14 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### ABBREVIATIONS

| Abbreviation | Explanation |
|---|---|
| AF | Application Function |
| AMF | Access Management Function |
| AUSF | Authentication Function |
| BSS | Business support system |
| DNN | Data Network Name |
| gNB | Next generation NodeB as defined in 3GPP (5G radio) |
| MBB | Mobile Broad Band |
| MDAF | Management Data Analytics |
| NEF | Network Exposure Function |
| NIDD | Non-IP Data Delivery |
| NF | Network Function |
| NFV | Network Function Virtualization (defined by ETSI) |
| NFVO | NFV orchestrator |
| Nudr | Service Based interface to UDR |
| OSS | Operations support system |
| PCF | Policy Control Function |
| PFD | Packet flow description |
| UDM | User Data Management |
| UDR | User Data Repository |
| UDSF | Unstructured Data Storage Function |
| UE | User Equipment |
| SMF | Session Management Function |
| S-NSSAI | Single network slice selection assistance information |
| VNF | Virtualized Network Function |
| uService | SW technology based on, e.g. Kubernetes, Istio |
| 5GC | 5G Core Network |

1. A method performed by a first User Equipment, UE, for applying policy enforcement for data traffic in an Uplink, UL, session, which UL data session is from the first UE to a data network via a Radio Access Network, RAN, a Core Network, CN, and a first Network Slice, NS, in a radio communications network, the method comprising:
obtaining first information from a CN node in the CN, which first information relates to:
policy enforcement data for the first NS, and
data traffic from second UEs via the RAN, the CN and second NSs, which data traffic information relates to a radio coverage area associated with the location of the first UE,
upon establishing the UL data session, measuring data traffic performance and radio conditions in the RAN,
predicting available resources for transmitting data from the first UE towards the data network via the RAN, the CN, and the first NS, based on the obtained first information, the measured data traffic performance and radio conditions in the RAN, and
applying policy enforcement for the data traffic in the UL data session based on the prediction.

2. The method according to claim 1, when the first UE is moving into a second location,
obtaining second information from the CN node in the CN, which second information relates to:
data traffic from second UEs via the RAN, the CN and second NSs, which data traffic information relates to a radio coverage area associated with the second location of the first UE,
when being located in the second area, measuring data traffic performance and radio conditions in the RAN,
predicting second available resources for transmitting data from the first UE towards the data network via the RAN, the CN, and the first NS, based on the policy enforcement data for the first NS obtained in the first information, the obtained second information, the data traffic performance and radio conditions in the RAN measured when being located in the second area, and
reapplying policy enforcement for the data traffic in the UL data session based on the prediction of the second available resources.

3. The method according to claim 1, wherein the policy enforcement data for the first NS comprises any one or more out of:
location information of the first UE,
a QoS priority level to use,
maximum throughput to use in the first and/or second area,
a time of day which policy enforcement to use,
if the policy enforcement activated or not.

4. The method according to claim 1, further comprising:
obtaining from the CN node a command to start or stop the process for predicting available resources, and applying policy enforcement for the data traffic in the UL data session based on the prediction.

5. (canceled)

6. (canceled)

7. A method performed by a Core Network, CN, node, for assisting a first User Equipment, UE, in applying policy enforcement for data traffic in an Uplink, UL, session, which UL data session is from the first UE to a data network via a Radio Access Network, RAN, a Core Network, CN, and a first Network Slice, NS, in a radio communications network, the method comprising:
collecting policy enforcement data for the first NS,
collecting information relating to data traffic from second UEs via the RAN, the CN and second NSs, which data traffic information relates to a radio coverage area associated with the location of the first UE,
assisting the first UE, by sending a first information to the first UE, which first information relates to the collected:
policy enforcement data for the specific NS, and
data traffic from the second UEs via the RAN, the CN and second NSs,
which sent information assists the first UE to predict available resources for transmitting data traffic in the UL data session based on the sent information, and apply the policy enforcement for the data traffic in the UL data session based on the prediction.

8. The method according to claim 7, wherein the first UE is moving into a second location, the method further comprising:
collecting further information relating to data traffic from second UEs via the RAN, the CN and second NSs, which data traffic information relates to a radio coverage area associated with the second location of the first UE,
assisting the first UE, by sending a second information to the UE, which second information relates to the further collected data traffic from the second UEs via the RAN, the CN and second NSs,
which sent second information assists the first UE to:
predict second available resources for transmitting data traffic in the UL data session based on the policy enforcement data for the first NS obtained in the first information, and the sent second information, and
reapply the policy enforcement for the data traffic in the UL data session based on the prediction.

9. The method according to claim 7, further comprising:
sending to the first UE, a command to start the process for predicting available resources, and applying policy enforcement for the data traffic in the UL data session based on the prediction.

10. (canceled)

11. (canceled)

12. A first User Equipment, UE, configured to apply policy enforcement for data traffic in an Uplink, UL, session, which UL data session is adapted to be from the first UE to a data network via a Radio Access Network, RAN, a Core Network, CN, and a first Network Slice, NS, in a radio communications network, the first UE being configured to:
obtain first information from a CN node in the CN, which first information is adapted to relate to:
policy enforcement data for the first NS, and
data traffic from second UEs via the RAN, the CN and second NSs, which data traffic information relates to a radio coverage area associated with the location of the first UE,
upon establishing the UL data session, measure data traffic performance and radio conditions in the RAN,
predict available resources for transmitting data from the first UE towards the data network via the RAN, the CN, and the first NS, based on the obtained first information, the measured data traffic performance and radio conditions in the RAN, and
apply policy enforcement for the data traffic in the UL data session based on the prediction.

13. The UE according to claim 12, when the first UE is adapted to move into a second location, the UE further being configured to:
obtain second information from a CN node in the CN, which second information is adapted to relate to:
data traffic from second UEs via the RAN, the CN and second NSs, which data traffic information relates to a radio coverage area associated with the second location of the first UE,
when being located in the second area, measure data traffic performance and radio conditions in the RAN,
predict second available resources for transmitting data from the first UE towards the data network via the RAN, the CN, and the first NS, based on the policy enforcement data for the first NS obtained in the first information, the obtained second information, the data traffic performance and radio conditions in the RAN measured when being located in the second area, and
reapply policy enforcement for the data traffic in the UL data session based on the prediction of the second available resources.

14. The UE according to claim 12, further being configured to:
obtain from the CN node, a command to start or stop the process for predicting available resources, and applying policy enforcement for the data traffic in the UL data session based on the prediction.

15. A Core Network, CN, node, configured to assist a first User Equipment, UE, in applying policy enforcement for data traffic in an Uplink, UL, session, which UL data session is from the first UE to a data network via a Radio Access Network, RAN, a Core Network, CN, and a first Network Slice, NS, in a radio communications network, the CN node being configured to:
collect policy enforcement data for the first NS,
collect information relating to data traffic from second UEs via the RAN, the CN and second NSs, which data traffic information is adapted to relate to a radio coverage area associated with the location of the first UE,
assist the first UE, by sending a first information to the UE, which first information is adapted to relate to the collected:
policy enforcement data for the specific NS, and
data traffic from the second UEs via the RAN, the CN and second NSs,
which sent information is adapted to assist the first UE to predict available resources for transmitting data traffic in the UL data session based on the sent information, and apply the policy enforcement for the data traffic in the UL data session based on the prediction.

16. The CN node according to claim 15, wherein the first UE is moving into a second location, the CN node further being configured to:
collect further information relating to data traffic from second UEs via the RAN, the CN and second NSs, which data traffic information is adapted to relates to a radio coverage area associated with the second location of the first UE,
assist the first UE, by sending a second information to the first UE, which second information is adapted to relate to the further collected data traffic from the second UEs via the RAN, the CN and second NSs,
which sent second information is adapted to assist the first UE to:
predict second available resources for transmitting data traffic in the UL data session based on the policy enforcement data for the first NS obtained in the first information, and the sent second information, and
reapply the policy enforcement for the data traffic in the UL data session based on the prediction.

17. The CN node according to claim 15, further being configured to:
send to the first UE, a command to start the process for predicting available resources, and applying policy enforcement for the data traffic in the UL data session based on the prediction.
